(19) United States
(12) Patent Application Publication
(10) Pub. No.: US 2024/0263681 A1
(43) Pub. Date: Aug. 8, 2024

(54) PISTON VALVE ASSEMBLY AND SHOCK ABSORBER WITH THE SAME

(71) Applicant: HL MANDO CORPORATION, Pyeongtaek-si (KR)

(72) Inventor: Eunjoong KIM, Hwaseong-si (KR)

(73) Assignee: HL MANDO CORPORATION, Pyeongtaek-si (KR)

(21) Appl. No.: 18/534,145

(22) Filed: Dec. 8, 2023

(30) Foreign Application Priority Data
Feb. 6, 2023 (KR) 10-2023-0015333

(51) Int. Cl. F16F 9/516

(52) U.S. Cl. CPC F16F 9/516

(57) ABSTRACT

A piston valve assembly includes: a piston valve main body mounted on a piston rod, dividing a cylinder into a compression chamber and a rebound chamber, having a compression channel and a tension channel formed to penetrate in a direction connecting the compression chamber and the rebound chamber, and configured to adjust a movement of a working fluid between the compression chamber and the rebound chamber; a first disc valve configured to open or close the compression channel of the piston valve main body in a direction in which the piston valve main body faces the rebound chamber; and a second disc valve configured to open or close the tension channel of the piston valve main body in a direction in which the piston valve main body faces the compression chamber and having a relatively smaller diameter than that of the first disc valve.

### CROSS-REFERENCE TO RELATED APPLICATIONS

This application claims benefit and priority to Korean Patent Application No. 10-2023-0015333, filed on Feb. 6, 2023, with the Korean Intellectual Property Office, the disclosure of which is incorporated herein in its entirety by reference.

### TECHNICAL FIELD

The present disclosure relates to a piston valve assembly and a shock absorber having the same, and more particularly, to a piston valve assembly capable of generating different damping forces during a compression stroke and a tension stroke of a piston valve, and a shock absorber having the same.

### BACKGROUND

In general, a damping device is installed in a vehicle to improve riding comfort by buffering shock or vibration that an axle receives from a road surface during driving, and a shock absorber is used as one of the damping devices.

The shock absorber is also called a damper and operates according to the vibration of a vehicle according to the conditions of a road surface. At this time, a damping force generated in the shock absorber is changed according to an operating speed of the shock absorber, that is, according to whether the operating speed is fast or slow.

It is very important to control damping force characteristics of the shock absorber when designing a vehicle because the ride comfort and driving stability of a vehicle can be controlled depending on how to adjust the damping force characteristics generated in the shock absorber.

For example, the shock absorber includes a cylinder filled with a working fluid such as oil, a piston rod connected to a vehicle body and reciprocating, and a piston valve coupled to the lower end of the piston rod to slide in the cylinder to control the flow of the working fluid.

Meanwhile, a piston valve commonly used in the shock absorber is designed to generate the damping force at the time of compression stroke and tension stroke, respectively, using the same channel.

In this way, when the damping force is generated using the same channel, there is a problem in that sufficient damping force is not generated while the damping force is reduced during the tension stroke in some cases.

### SUMMARY

An embodiment of the present disclosure provides a piston valve assembly capable of generating a damping force required during a compression stroke and a tension stroke, respectively, and a shock absorber having the same.

According to an embodiment of the present disclosure, there is provided a piston valve assembly generating a damping force during a compression stroke and a tension stroke of a shock absorber, the piston valve assembly including: a piston valve main body mounted on a piston rod of the shock absorber, dividing a cylinder into a compression chamber and a rebound chamber, having a compression channel and a tension channel formed to penetrate in a direction connecting the compression chamber and the rebound chamber, and configured to adjust a movement of a working fluid between the compression chamber and the rebound chamber; a first disc valve configured to open or close the compression channel of the piston valve main body in a direction in which the piston valve main body faces the rebound chamber; and a second disc valve configured to open or close the tension channel of the piston valve main body in a direction in which the piston valve main body faces the compression chamber and having a relatively smaller diameter than that of the first disc valve.

The compression channel of the piston valve main body may be formed at a position relatively farther from an axial center of the piston rod than the tension channel.

The first disc valve may have a radius greater than a distance from an axial center of the piston rod to the compression channel, and the second disc valve may have a radius greater than a distance from the axial center of the piston rod to the tension channel and smaller than a distance from the axial center of the piston rod to the compression channel.

The piston valve assembly may further include a retainer interposed between the piston valve main body and the first disc valve.

The retainer may be in contact with one region of the piston valve main body where the compression channel is formed and have a compression connection channel connected to the compression channel of the piston valve main body.

The first disc valve may be in contact with the retainer and open or close the compression connection channel of the retainer connected to the compression channel of the piston valve main body.

The retainer may be spaced apart from other regions of the piston valve main body where the tension channel is formed, and during the tension stroke, the working fluid in the rebound chamber may flow into the tension channel of the piston valve main body through a space separated between the retainer and the piston valve main body.

The second disc valve may be in contact with the piston valve main body to open or close the tension channel of the piston valve main body.

The first disc valve may have a relatively lower stiffness than the second disc valve and be configured to generate a relatively lower damping force during the compression stroke than during the tension stroke.

The piston valve assembly may further include a first washer installed in a direction opposite to a direction in which the first disc valve faces the piston valve main body, a piston nut fastened to an end of the piston rod passing through the piston valve main body, the first disc valve, and the second disc valve in sequence, and a second washer provided between the piston nut and the second disc valve.

According to another embodiment of the present disclosure, there is provided a shock absorber including: a cylinder filled with a working fluid; a piston rod reciprocating within the cylinder; and a piston valve main body mounted on the piston rod, dividing the cylinder into a compression chamber and a rebound chamber, and controlling movement of the working fluid between the compression chamber and the rebound chamber, in which the piston valve main body includes a piston valve main body having a compression channel and a tension channel formed to penetrate in a direction connecting the compression chamber and the rebound chamber, a first disc valve configured to open or close the compression channel of the piston valve main body in a direction in which the piston valve main body faces the rebound chamber, and a second disc valve configured to open or close the tension channel of the piston valve main body in a direction in which the piston valve main body faces the compression chamber and having a relatively smaller diameter than that of the first disc valve.

The compression channel of the piston valve main body may be formed at a position relatively farther from an axial center of the piston rod than the tension channel.

The first disc valve may have a radius greater than a distance from an axial center of the piston rod to the compression channel, and the second disc valve may have a radius greater than a distance from the axial center of the piston rod to the tension channel and smaller than a distance from the axial center of the piston rod to the compression channel.

The piston valve assembly may further include a retainer interposed between the piston valve main body and the first disc valve.

The retainer may be in contact with one region of the piston valve main body where the compression channel is formed and have a compression connection channel connected to the compression channel of the piston valve main body.

The first disc valve may be in contact with the retainer and open or close the compression connection channel of the retainer connected to the compression channel of the piston valve main body.

The retainer may be spaced apart from other regions of the piston valve main body where the tension channel is formed, and during the tension stroke, the working fluid in the rebound chamber may flow into the tension channel of the piston valve main body through a space separated between the retainer and the piston valve main body.

The second disc valve may be in contact with the piston valve main body to open or close the tension channel of the piston valve main body.

The first disc valve may have a relatively lower stiffness than the second disc valve and be configured to generate a relatively lower damping force during the compression stroke than during the tension stroke.

The piston valve assembly may further include a first washer installed in a direction opposite to a direction in which the first disc valve faces the piston valve main body, a piston nut fastened to an end of the piston rod passing through the piston valve main body, the first disc valve, and the second disc valve in sequence, and a second washer provided between the piston nut and the second disc valve.

According to an embodiment of the present disclosure, a piston valve assembly and a shock absorber having the same can effectively generate a damping force required during a compression stroke and a tension stroke, respectively.

### BRIEF DESCRIPTION OF THE DRAWINGS

FIG. 1 is a cross-sectional view illustrating a piston valve assembly and a shock absorber having the same according to one embodiment of the present disclosure.

FIG. 2 is an exploded perspective view of the piston valve assembly of FIG. 1.

FIGS. 3 and 4 are cross-sectional views for explaining an operating state of the shock absorber of FIG. 1.

### DETAILED DESCRIPTION

Hereinafter, with reference to the accompanying drawings, embodiments of the present disclosure will be described in detail so that a person having ordinary knowledge in the technical field to which the present disclosure belongs can easily practice it. The present disclosure may be implemented in several different forms and is not limited to the embodiments described herein.

It is advised that the drawings are schematic and not drawn to scale. Relative dimensions and proportions of parts in the drawings are illustrated exaggerated or reduced in size for clarity and convenience in the drawings, and any dimensions are illustrative only and not limiting. Moreover, similar reference numerals are used for similar structures, elements, or parts appearing in two or more drawings to indicate similar features.

Embodiments of the present disclosure specifically represents ideal embodiments of the present disclosure. As a result, various variations of the diagram are expected. Therefore, the embodiments are not limited to the specific shape of the illustrated area, and includes, for example, modification of the shape by manufacturing.

In addition, all technical terms and scientific terms used in the present specification have meanings commonly understood by those of ordinary skill in the art to which the present disclosure belongs, unless otherwise defined. All terms used in the present specification are selected for the purpose of more clearly explaining the present disclosure, and are not selected to limit the scope of rights according to the present disclosure.

In addition, expressions such as “comprising”, “including”, “having”, or the like used in the present specification should be understood in open-ended terms to including the possibility of including other embodiments, unless otherwise stated in the phrase or sentence in which the expression is included.

In addition, singular expressions described in the present specification may include plural meanings unless otherwise stated, and this applies to singular expressions described in the claims as well.

In addition, expressions such as “first” and “second” used in the present specification are used to distinguish a plurality of components from each other, and do not limit the order or importance of the components.

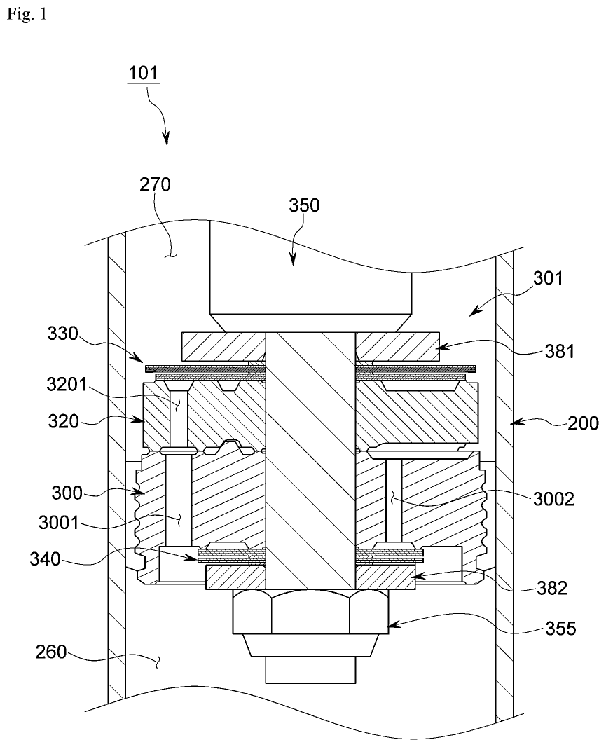

Hereinafter, a piston valve assembly 301 according to one embodiment of the present disclosure and a shock absorber 101 having the same will be described with reference to FIGS. 1 to 4. Here, the shock absorber is also called a damper, and for example, the shock absorber is installed in a vehicle and may be used to absorb and buffer shock or vibration that an axle receives from a road surface during driving.

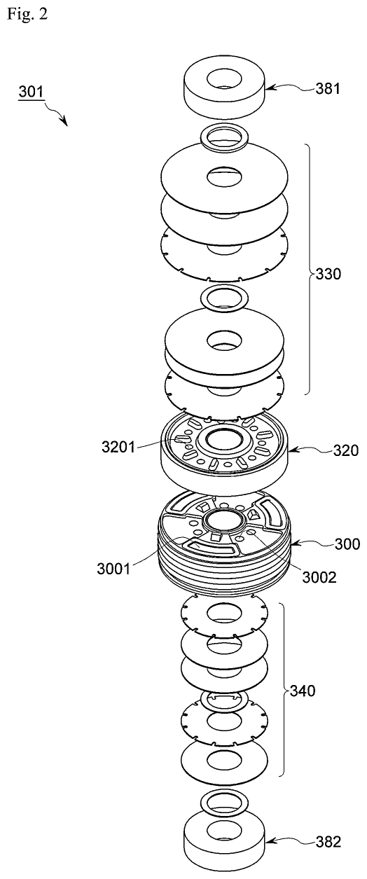

As illustrated in FIGS. 1 and 2, the shock absorber 101 includes a cylinder 200, a piston rod 350, and a piston valve assembly 301.

The cylinder 200 may have a cylindrical shape forming a space therein, and the inside of the cylinder 200 is filled with a working fluid. Here, the inside of the first cylinder 210 may be divided into a compression chamber 260 and a rebound chamber 270 by the piston valve assembly 301 described later. For example, based on the piston valve assembly 301, an upper portion of the cylinder 200 may become the rebound chamber 270, and a lower portion of the cylinder 200 may become a compression chamber 260.

The piston rod 350 can reciprocate within the cylinder 200. For example, one side of the piston rod 350 is located inside the cylinder 200 and the other side of the piston rod 350 extends to the outside of the cylinder 200 and may be connected to a vehicle body or wheel side. A piston valve assembly 301 to be described later is mounted on one side of the piston rod 350.

The piston valve assembly 301 is mounted on the piston rod 350, divides the cylinder 200 into the compression chamber 260 and the rebound chamber 270, and controls the movement of the working fluid between the compression chamber 260 and the rebound chamber 270. In particular, in one embodiment of the present disclosure, the piston valve assembly 301 can generate a differentiated damping force required for during a compression stroke and a tension stroke.

Specifically, the piston valve assembly 301 includes a piston valve main body 300, a first disc valve 330, and a second disc valve 340.

In addition, the piston valve assembly 301 may further include a retainer 320, a first washer 381, a second washer 382, and a piston nut 355.

The piston valve main body 300 is mounted on the piston rod 350 to control the movement of the working fluid between the compression chamber 260 and the rebound chamber 270. That is, the piston valve main body 300 may be provided to reciprocate the inside of the cylinder 200 filled with the working fluid together with the piston rod 350 in a state in which the piston rod 350 is penetrated. In addition, the piston valve main body 300 includes a compression channel 3001 and tension channel 3002 formed to penetrate in a direction connecting the compression chamber 260 and the rebound chamber 270 so that the fluid can move between the compression chamber 260 and the rebound chamber 270.

For example, during the tension stroke, the pressure of the rebound chamber 270 increases relatively higher than that of the compression chamber 260 according to the movement of the piston rod 350, and due to the increase in pressure of the rebound chamber 270, the working fluid filling the rebound chamber 270 moves to the compression chamber 260 through the tension channel 3002 of the piston valve main body 300. On the contrary, during the compression stroke, during the compression stroke, the pressure of the compression chamber 260 increases relatively higher than that of the rebound chamber 270 according to the movement of the piston rod 350, and due to the increase in pressure of the compression chamber 260, the working fluid filling the compression chamber 260 moves to the rebound chamber 270 through the compression channel 3001 of the piston valve main body 300.

In addition, in one embodiment of the present disclosure, the compression channel 3001 of the piston valve main body 300 may be formed at a position relatively farther from an axial center of the piston rod 350 than the tension channel 3002.

The first disc valve 330 opens or closes the compression channel 3001 of the piston valve main body 300 in a direction in which the piston valve main body 300 faces the rebound chamber 270. Moreover, the first disc valve 330 may have a radius longer than a maximum distance from the axial center of the piston rod 350 to the compression channel 3001.

The second disc valve 340 opens or closes the tension channel 3002 of the piston valve main body 300 in a direction where the piston valve main body 300 faces the compression chamber 260. In this case, the second disc valve 340 has a relatively smaller diameter than the first disc valve 330. Moreover, the second disc valve 340 may have a radius greater than the maximum distance from the axial center of the piston rod 350 to the tension channel 3002 and smaller than the minimum distance from the axial center of the piston rod 350 to the compression channel 3001.

As described above, the second disc valve 340 having a relatively smaller diameter than that of the first disc valve 330 has a relatively higher stiffness than the first disc valve 340. In this case, the first disc valve 330 and the second disc valve 340 may be made of the same material. For example, the first disc valve 330 having a relatively large diameter is more easily deformed than the second disc valve 340 having a relatively small diameter, similar to the principle of force acting on a cantilever. Considering this point, it can be expressed that the second disc valve 340 has a relatively higher stiffness than the first disc valve 340.

That is, since the second disc valve 340 has a higher stiffness than that of the first disc valve 330 and opens or closes the tension channel 3002, a higher damping force is generated when the working fluid moves through the tension channel 3002 during the tension stroke than when the working fluid moves through the compression channel 3001 during the compression stroke.

Conversely, since the first disc valve 330 has a relatively lower stiffness than that of the second disc valve 340, a relatively lower damping force is generated during the compression stroke than during the tension stroke.

The retainer 320 may be coupled to the piston rod 350 and interposed between the piston valve main body 300 and the first disc valve 330.

Specifically, the retainer 320 may be placed in contact with one region of the piston valve main body 300 where the compression channel 3001 is formed, and may have a compression connection channel 3201 connected to the compression channel 3001 of the piston valve main body 300. During the compression stroke, the working fluid in the compression chamber 260 moves to the rebound chamber 270 through the compression channel 3001 of the piston valve main body 300 and the compression connection channel 3201 of the retainer 320. In addition, the first disc valve 330 may open or close the compression connection channel 3201 of the retainer 320 connected to the compression channel 3001 of the piston valve main body 300 in contact with the retainer 320. That is, as the first disc valve 330 opens or closes the compression connection channel 3201 of the retainer 320, the compression channel 3001 of the piston valve main body 300 also opens or closes. As such, the first disc valve 330 does not open or close the compression channel 3001 in direct contact with the piston valve main body 300, but opens or closes the compression connection channel 3201 of the retainer 320 in contact with the retainer 320. Accordingly, it is possible to indirectly open or close the compression channel 3001 of the piston valve main body 300.

Moreover, the retainer 320 may be spaced apart from other regions of the piston valve main body 300 where the tension channel 3002 is formed. During the tension stroke, the working fluid of the rebound chamber 270 flows into the tension channel of the piston valve main body 300 through the spaced space between the retainer 320 and the piston valve main body 300 and moves toward the compression chamber 260. In addition, the second disc valve 340 may be in contact with the piston valve main body 300 to open or close the tension channel 3002 of the piston valve main body 300.

Meanwhile, one embodiment of the present disclosure is not limited to the above, and the retainer 320 may be omitted. When the retainer 320 is omitted, the first disc valve 330 may be in direct contact with the piston valve main body 300 to open or close the compression channel 3001.

However, when the retainer 320 is omitted, the first disc valve 330 having a relatively larger diameter than that of the second disc valve 340 may block the tension channel 3002 of the piston valve main body 300 in the direction where the piston valve main body 300 faces the rebound chamber 270. Accordingly, to avoid this, it is necessary to process the shape of the first disc valve 330 or additionally process and form a bypass channel in the piston valve main body 300 to avoid blocking the tension channel 3002 by the first disc valve 330.

However, processing the shape of the first disc valve 330 or additionally processing the piston valve main body 300 in this way not only reduces the durability of the product than using the retainer 320, but also increases the manufacturing cost and reduces productivity. For example, when too many shapes are machined into the piston valve main body 300, the strength of the piston valve main body 300 is lowered, resulting in a decrease in durability. The piston valve main body 300 is fastened to the piston rod 350 with strong force by a piston nut 355 described later. However, when the strength of the piston valve main body 300 is reduced, the piston valve main body 300 may be damaged when the piston nut 355 is fastened.

The first washer 381 may be installed in a direction opposite to the direction in which the first disc valve 330 faces the piston valve main body 300. That is, the first washer 381 may be interposed between the first disc valve 330 and the body of the piston rod 350. The first washer 381 may protect the first disc valve 330 and the piston valve main body 300.

The piston nut 355 may be fastened to an end of the piston rod 350 that sequentially passes through the piston valve main body 300, the first disc valve 330, and the second disc valve 340. That is, the piston nut 355 can prevent the piston valve assembly 301 from being separated from the piston rod 350.

The second washer 382 may be provided between the piston nut 355 and the second disc valve 340. The second washer 382 may protect the second disc valve 340 and the piston valve main body 300.

With this configuration, the piston valve assembly 301 according to an embodiment of the present disclosure and the shock absorber 102 having the same can differentiate and effectively generate the damping force required during the compression stroke and the tension stroke, respectively, as necessary.

Specifically, by changing the diameters of the first disc valve 330 and the second disc valve 340, the first disc valve 330 is configured to have a relatively lower stiffness than that of the second disc valve 340. Accordingly, a relatively lower damping force can be generated in the compression stroke than in the tension stroke.

For example, as the diameter of the first disc valve 330 increases, deformation is relatively easier to occur similar to the principle of force acting on a cantilever, and a low damping force is generated. In addition, as the diameter of the second disc valve 340 decreases, the deformation is relatively difficult to occur, and thus, a high damping force is generated.

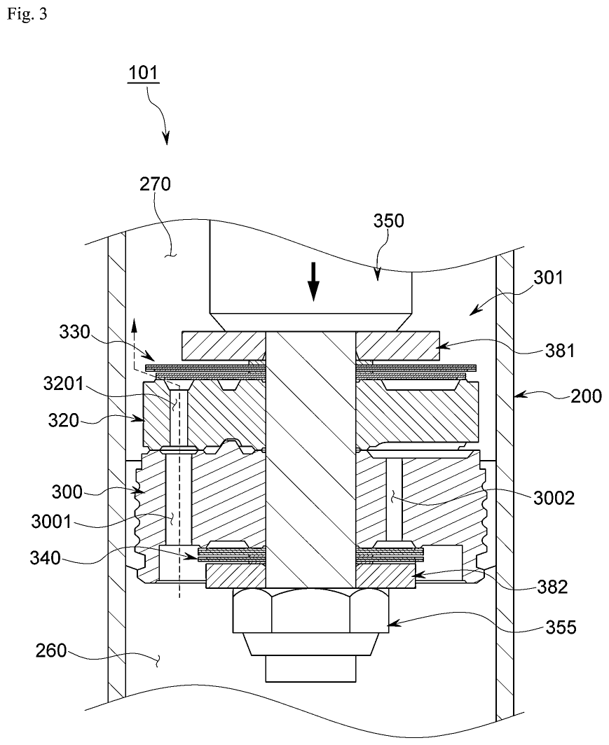

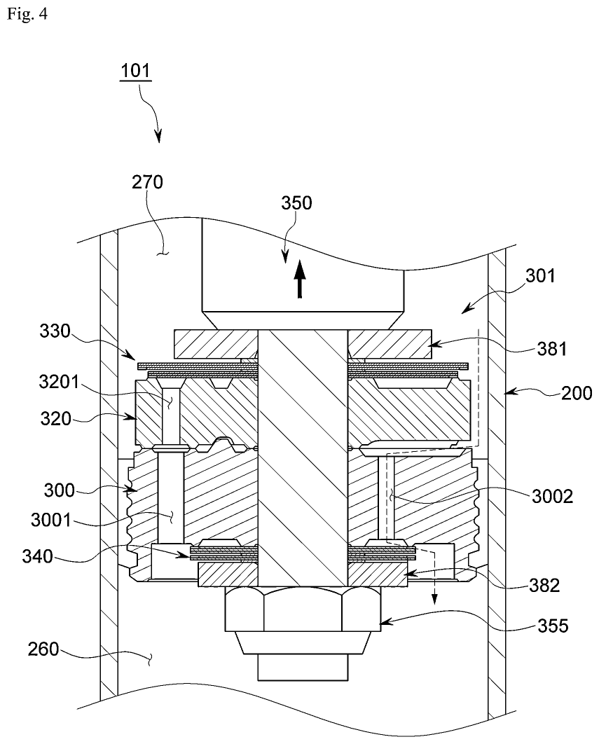

Hereinafter, with reference to FIGS. 3 and 4, operating states of the piston valve assembly 301 and the shock absorber 102 having the piston valve assembly 301 according to one embodiment of the present disclosure will be described in detail.

First, as illustrated in FIG. 3, when the piston valve assembly 301 moves in the direction of the compression chamber 260 during the compression stroke, the working fluid in the compression chamber 260 moves in the direction of the rebound chamber 270 through the compression channel 3001 of the piston valve main body 300 and the compression connection channel 3201 of the retainer 320. In this case, the first disc valve 330 is blocking the compression connection channel 3201 of the retainer 320, and as the pressure of the compression chamber 260 increases, the first disc valve 330 is opened by the pressure of the compression chamber 260 and the damping force is generated.

The first disc valve 330 has a relatively larger diameter than that of the second disc valve 340, and the distance from the axial center of the piston rod 350 to the compression channel 3001 blocked by the first disc valve 330 is longer than the distance from the axial center of the piston rod 350 to the tension channel 3002 blocked by the second disc valve 340. Accordingly, the force that the first disc valve 330 blocks the compression channel 3001 is relatively weaker than the force that the second disc valve 340 blocks the tension channel 3002.

Therefore, the damping force generated by the first disc valve 330 during the compression stroke is relatively weaker than the damping force generated by the second disc valve 340 during the tension stroke.

Next, as illustrated in FIG. 4, when the piston valve assembly 301 moves in the direction of the rebound chamber 270 during the tension stroke, the working fluid in the rebound chamber 270 moves in the direction of the compression chamber 260 through the tension channel 3002 of the piston valve main body 300. In this case, the second disc valve 340 is blocking the tension channel 3002 of the piston valve main body 300, and as the pressure of the rebound chamber 270 increases, the second disc valve 340 is opened by the pressure of the rebound chamber 270 and a damping force is generated.

The second disc valve 340 has a relatively smaller diameter than that of the first disc valve 330, and the distance from the axial center of the piston rod 350 to the tension channel 3002 blocked by the second disc valve 340 is shorter than the distance from the axial center of the piston rod 350 to the compression channel 3001 blocked by the first disc valve 330. Accordingly, the force that the second disc valve 340 blocks the tension channel 3002 is relatively greater than the force that the first disc valve 330 blocks the tension channel 3001.

Therefore, the damping force generated by the second disc valve 340 during the tension stroke is relatively greater than the damping force generated by the first disc valve 330 during the compression stroke.

As described above, by adjusting the diameters of the first disc valve 330 and the second disc valve 340 together with the distance from the axial center of the piston rod 350 to the position where the compression channel 3001 of the piston valve main body 300 is formed and the distance from the axial center of the piston rod 350 to the position where the tension channel 3002 of the piston valve main body 300 is formed, the damping force generated during the compression stroke of the shock absorber 101 and the damping force generated during the tension stroke can be finely adjusted independently.

For example, the shock absorber 101 may be made to generate a basic damping force during the compression stroke while increasing the damping force generated during the tension stroke.

In this way, the piston valve assembly 301 according to one embodiment of the present disclosure and the shock absorber 101 having the same can differentiate and effectively generate the damping force required during the compression stroke and the tension stroke, respectively, as necessary.

Although the embodiments of the present disclosure have been described with reference to the accompanying drawings, those skilled in the art to which the present disclosure belongs know that the present disclosure can be implemented in other specific forms without changing its technical spirit or essential features.

Therefore, the embodiments described above should be understood as illustrative in all respects and not limiting, the scope of the present disclosure is indicated by claims to be described later, and all changes or modified forms derived from the meaning and scope of the claims and their equivalent concepts should be construed as being included in the scope of the present disclosure.

[Detailed Description of Main Elements]

| | |
|---|---|
| 101: shock absorber | 200: cylinder |
| 260: compression chamber | 270: rebound chamber |
| 300: piston valve main body | 301: piston valve assembly |
| 320: retainer | 330: first disc valve |
| 340: second disc valve | 350: piston rod |
| 355: piston nut | 381: first washer |
| 382: second washer | 3001: compression channel |
| 3002: tension channel | 3201: compression connection channel |

What is claimed is:

1. A piston valve assembly generating a damping force during a compression stroke and a tension stroke of a shock absorber, the piston valve assembly comprising:
a piston valve main body mounted on a piston rod of the shock absorber, dividing a cylinder into a compression chamber and a rebound chamber, having a compression channel and a tension channel formed to penetrate in a direction connecting the compression chamber and the rebound chamber, and configured to adjust a movement of a working fluid between the compression chamber and the rebound chamber;
a first disc valve configured to open or close the compression channel of the piston valve main body in a direction in which the piston valve main body faces the rebound chamber; and
a second disc valve configured to open or close the tension channel of the piston valve main body in a direction in which the piston valve main body faces the compression chamber and having a relatively smaller diameter than that of the first disc valve.

2. The piston valve assembly of claim 1, wherein the compression channel of the piston valve main body is formed at a position relatively farther from an axial center of the piston rod than the tension channel.

3. The piston valve assembly of claim 1, wherein the first disc valve has a radius greater than a distance from an axial center of the piston rod to the compression channel, and
the second disc valve has a radius greater than a distance from the axial center of the piston rod to the tension channel and smaller than a distance from the axial center of the piston rod to the compression channel.

4. The piston valve assembly of claim 1, further comprising a retainer interposed between the piston valve main body and the first disc valve.

5. The piston valve assembly of claim 4, wherein the retainer is in contact with one region of the piston valve main body where the compression channel is formed and has a compression connection channel connected to the compression channel of the piston valve main body.

6. The piston valve assembly of claim 5, wherein the first disc valve is in contact with the retainer and opens or closes the compression connection channel of the retainer connected to the compression channel of the piston valve main body.

7. The piston valve assembly of claim 4, wherein the retainer is spaced apart from other regions of the piston valve main body where the tension channel is formed, and
during the tension stroke, the working fluid in the rebound chamber flows into the tension channel of the piston valve main body through a space separated between the retainer and the piston valve main body.

8. The piston valve assembly of claim 7, wherein the second disc valve is in contact with the piston valve main body to open or close the tension channel of the piston valve main body.

9. The piston valve assembly of claim 1, wherein the first disc valve has a relatively lower stiffness than the second disc valve and is configured to generate a relatively lower damping force during the compression stroke than during the tension stroke.

10. The piston valve assembly of claim 1, further comprising:
a first washer installed in a direction opposite to a direction in which the first disc valve faces the piston valve main body;
a piston nut fastened to an end of the piston rod passing through the piston valve main body, the first disc valve, and the second disc valve in sequence; and
a second washer provided between the piston nut and the second disc valve.

11. A shock absorber comprising:
a cylinder filled with a working fluid;
a piston rod reciprocating within the cylinder; and
a piston valve main body mounted on the piston rod, dividing the cylinder into a compression chamber and a rebound chamber, and controlling movement of the working fluid between the compression chamber and the rebound chamber,
wherein the piston valve main body includes
a piston valve main body having a compression channel and a tension channel formed to penetrate in a direction connecting the compression chamber and the rebound chamber,
a first disc valve configured to open or close the compression channel of the piston valve main body in a direction in which the piston valve main body faces the rebound chamber, and
a second disc valve configured to open or close the tension channel of the piston valve main body in a direction in which the piston valve main body faces the compression chamber and having a relatively smaller diameter than that of the first disc valve.

12. The shock absorber of claim 11, wherein the compression channel of the piston valve main body is formed at a position relatively farther from an axial center of the piston rod than the tension channel.

13. The shock absorber of claim 11, wherein the first disc valve has a radius greater than a distance from an axial center of the piston rod to the compression channel, and the second disc valve has a radius greater than a distance from the axial center of the piston rod to the tension channel and smaller than a distance from the axial center of the piston rod to the compression channel.

14. The shock absorber of claim 11, wherein the piston valve assembly further includes a retainer interposed between the piston valve main body and the first disc valve.

15. The shock absorber of claim 14, wherein the retainer is in contact with one region of the piston valve main body where the compression channel is formed and has a compression connection channel connected to the compression channel of the piston valve main body.

16. The shock absorber of claim 15, wherein the first disc valve is in contact with the retainer and opens or closes the compression connection channel of the retainer connected to the compression channel of the piston valve main body.

17. The shock absorber of claim 14, wherein the retainer is spaced apart from other regions of the piston valve main body where the tension channel is formed, and
during the tension stroke, the working fluid in the rebound chamber flows into the tension channel of the piston valve main body through a space separated between the retainer and the piston valve main body.

18. The shock absorber of claim 17, wherein the second disc valve is in contact with the piston valve main body to open or close the tension channel of the piston valve main body.

19. The shock absorber of claim 11, wherein the first disc valve has a relatively lower stiffness than the second disc valve and is configured to generate a relatively lower damping force during the compression stroke than during the tension stroke.

20. The shock absorber of claim 11, wherein the piston valve assembly further includes
a first washer installed in a direction opposite to a direction in which the first disc valve faces the piston valve main body,
a piston nut fastened to an end of the piston rod passing through the piston valve main body, the first disc valve, and the second disc valve in sequence, and
a second washer provided between the piston nut and the second disc valve.
